(19) United States
(12) Patent Application Publication
(10) Pub. No.: US 2004/0174676 A1
(43) Pub. Date: Sep. 9, 2004

(54) Computer chassis for dissipating heat and shielding electromagnetic emissions

(76) Inventor: Chen Shi-Tsung, Taipei (TW)

Correspondence Address: FENWICK & WEST LLP, SILICON VALLEY CENTER, 801 CALIFORNIA STREET, MOUNTAIN VIEW, CA, 94041, US

(21) Appl. No.: 10/728,104

(22) Filed: Dec. 3, 2003

(30) Foreign Application Priority Data
Dec. 4, 2002 (TW) 091219657

(51) Int. Cl. G06F 1/20

(52) U.S. Cl. 361/687; 361/818; 361/704; 165/104.33; 165/80.3

(57) ABSTRACT

A computer chassis includes a mesh screen window that dissipates heat while simultaneously shielding electromagnetic emissions. The window may also allow the interior of the computer to be viewed through the window from outside the computer. In one embodiment, a metal mesh screen is mounted over an opening on a computer chassis. The open architecture and screen window allow the components inside the computer to be cooled by a flow of air while the mesh in the screen blocks electromagnetic radiation.

### CROSS REFERENCE TO RELATED APPLICATIONS

This application claims the right of priority based on Taiwanese application Ser. No. 091219657, filed Dec. 4, 2002, which is herein incorporated in its entirety by reference.

### BACKGROUND

1. Field of the Invention

This invention relates generally to a computer chassis, and more specifically to a computer chassis having a window that dissipates heat and shields electromagnetic emissions, and enables the interior of a computer to be viewed from outside the computer.

2. Background of the Invention

In their normal operation within computers, microprocessors and other electronic components generate both thermal and electromagnetic emissions. Such electromagnetic emissions need to be contained within the confines of computers to prevent interference with other electrical systems. In addition, the heat generated within a computer, if not properly dissipated, can damage or reduce the useful lifetime of integrated circuits and other electronic components. High temperatures can also slow the operation of these components and degrade their efficiency. Decreases in component size and increases in component processing capabilities have highlighted the challenge of controlling both of these kinds of emissions to limit their impact. These problems are further compounded for small motherboards that have limited real estate for mounting components, such as those found in small form factor computers. However, the distinct nature of each problem has made it difficult to devise a single solution. As one example, a completely open computer chassis architecture would allow for maximum airflow and the effective cooling of computer components; however, such an architecture would be ineffective at blocking the leakage of electromagnetic emissions into the environment surrounding the computer.

A related problem is the use of a transparent or partially transparent computer chassis. High-tech products, particularly those with precision elements, may be housed in transparent materials, such as glass or acrylic. Watches with clear faces are one example of such products. A clear housing can make internal product components visible to the user, even during the product's operation, and thus enhances the product's design appeal. However, when used in computer chassis, transparent materials do not effectively shield electromagnetic emissions generated by the computer components.

Thus, it is desirable to devise a single apparatus to both contain electromagnetic emissions and cool high temperatures within a computer. It is also desirable to provide an apparatus that allows the interior of a computer to be viewed from the outside while also providing electromagnetic shielding.

### SUMMARY OF THE INVENTION

Accordingly, the invention provides methods and apparati for containing electromagnetic emissions and dissipating thermal energy within a computer. In an embodiment, a computer chassis includes a window to enable the viewing of computer components within a computer from outside the computer. The window may be formed by an opening on a computer chassis covered by a mesh screen, which serves to both expend heat and contain electromagnetic radiation. The open window architecture allows for heat to escape from within the confines of the computer through the mesh screen. With a large surface area to mass ratio, the mesh facilitates heat transfer, also improving the thermal properties of the apparatus. The screen can also shield against the electromagnetic radiation generated by the computer components. In an embodiment, the screen is porous enough to afford a view of the interior of a computer from outside the computer, thus providing the aesthetic appeal of a transparent case while still providing a shield against motherboard emissions.

In one embodiment of the invention, a chassis comprises a panel with an opening on it. A mesh screen is mounted to the panel and covers the opening. Heat can escape from the interior of the chassis through the screen, however electromagnetic emissions are contained. Accordingly, the invention shields against electromagnetic interference and dissipates heat. In an embodiment, the interior of a computer is visible through the screen window of the chassis.

In another embodiment of the invention, a computer chassis has a mesh screen window. Air flow is directed away from components inside the computer chassis out of the chassis through the window, cooling the components. Emissions from the components are shielded and prevented from escaping from the chassis by the screen window. Through these steps, both cooling and shielding can be accomplished.

### BRIEF DESCRIPTION OF THE DRAWINGS

FIG. 1 is a perspective view of a computer chassis having a mesh window in accordance with an embodiment of the invention.

### DETAILED DESCRIPTION OF THE PREFERRED EMBODIMENTS

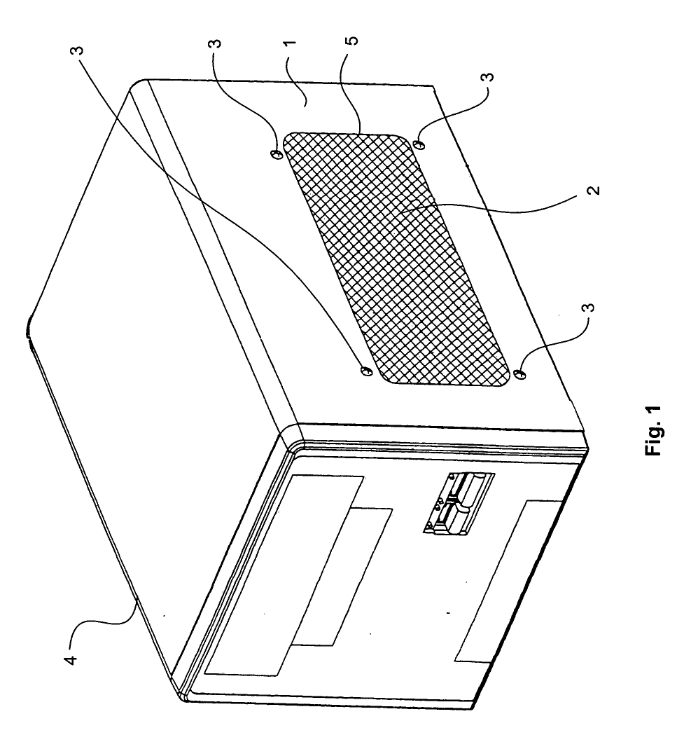

FIG. 1 illustrates an apparatus for dissipating heat, containing electromagnetic emissions, and enabling an ornamental computer design in accordance with one embodiment of the invention. In this embodiment, a computer chassis 4 is comprised of a number of panels. At least one of the panels 1 contains an opening 5. The opening 5 in the panel 1 is covered by a mesh screen 2, which is mounted to the panel 1. As depicted, the mesh screen 2 is mounted to using four screws 3; however, the screen may be mounted in alternative ways. Advantageously, the screen 2 allows for heat dissipation while it blocks electromagnetic emissions. In FIG. 1, the opening 5 in the panel 1 covers roughly half of the area of the panel 1 on which it appears, and is rectangular in shape. Alternatively, openings of other proportions and shapes are possible.

The mesh screen 2 may be of varying densities. For example, in one embodiment the screen 2 has a gauge at least 200 dots per square inch, and in another the screen 2 is selected to be porous enough to allow the interior components of the computer to be viewed from outside the computer. FIG. 1 shows the apparatus as implemented in a form factor computer chassis 4; however, the invention can be applied to a variety of computer sizes.

Now taking an example to explain the operation of an embodiment of the invention, an opening 5 in a panel 1 of a computer chassis 4 is provided. A mesh screen 2 is attached to the panel 1 to cover the opening 5. The screen 2 may be attached to the panel 1 using various mechanisms. For example, a series of screws 3 surrounding the opening in the panel 4 can be used. During operation, components within the computer generate heat and electromagnetic emissions. Heat flows from inside the computer through the open architecture of the screen window 2 outside the computer, where it is dissipated. In addition, the screen 2 can be made of a thermally conductive material to facilitate heat transfer. At the same time, electromagnetic emissions produced in the computer are effectively blocked by the screen window 2. The screen 2, which covers the opening 5 in the panel 1 of the chassis 4, prevents electromagnetic emissions that would otherwise leak outside the computer.

The screen 2 can have varying densities. These densities impact how effectively heat is released and emissions are blocked. For example, the more porous the mesh is, the more rapidly heat can escape through the screen window 2. In addition, the more dense the mesh is, generally, the more effectively emissions will be contained in the computer. In an embodiment, the screen 2 is porous enough that the components inside the computer are visible from outside the computer. However, the screen also vents heat and shields emissions. In so doing, the invention overcomes the design problems of the prior art. In an embodiment, the chassis 1 supports a small form factor computer. Alternatively, the chassis 1 can be for a computer of another size.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. It is therefore intended that the scope of the invention be limited not by this detailed description, but rather by the claims appended hereto.

I claim:

1. A chassis for limiting electromagnetic interference from and dissipating heat generated by computer components within a computer, the chassis comprising:
a panel on a side of the chassis, the panel having an opening; and
a mesh screen attached to the panel and covering the opening, the mesh screen suitable for blocking electromagnetic interference emissions from computer components within the chassis.

2. The chassis of claim 1, wherein the computer chassis is a chassis for a small form factor computer.

3. The chassis of claim 1, wherein the mesh screen comprises a thermally conductive material.

4. The chassis of claim 3, wherein the mesh screen comprises a metal.

5. The chassis of claim 1, wherein the mesh screen is attached to the panel by screws.

6. The chassis of claim 1, wherein the mesh screen has a gauge of at least 200 dots per square inch.

7. The chassis of claim 1, wherein the opening in the panel has a rectangular shape and comprises at least one half the area of the panel.

8. The chassis of claim 7, wherein the mesh screen is secured to the panel on the chassis by a screw near each corner of the rectangular opening around, the mesh screen mounted to an interior side of the panel.

9. The chassis of claim 1, wherein the computer components within the computer are visible from outside the computer through the mesh screen.

10. A method of limiting electromagnetic interference from and dissipating heat generated by computer components within a computer chassis having a porous window, the method comprising the steps:
directing air flow from within the chassis out of the chassis through the window, thereby cooling the computer components; and
preventing electromagnetic interference emissions generated by the computer components from escaping the chassis through the window by blocking the emissions with the window.

11. The method of claim 10, wherein the chassis is a chassis for a small form factor computer.

12. The method of claim 10, wherein the interior of a computer is visible from outside the computer through the porous window.

13. The method of claim 10, porous window has a hole density of at least 200 per square inch.
